(19) United States
(12) Patent Application Publication
(10) Pub. No.: US 2019/0257431 A1
(43) Pub. Date: Aug. 22, 2019

(54) FLUE DAMPER HAVING A DAMPER GATE, A SEAL, AND A FLANGE

(71) Applicant: FIELD CONTROLS, L.L.C., Kinston, NC (US)

(72) Inventors: Kyle Glover, Kinston, NC (US); Mark R. Lundberg, Greenville, NC (US); Eric A. Hokanson, Kinston, NC (US)

(73) Assignee: FIELD CONTROLS, L.L.C., Kinston, NC (US)

(21) Appl. No.: 16/281,565

(22) Filed: Feb. 21, 2019

Related U.S. Application Data
(60) Provisional application No. 62/633,867, filed on Feb. 22, 2018.

(51) Int. Cl. F16K 1/226; F23L 11/00; F16K 1/22; F16K 27/02

(52) U.S. Cl. CPC F16K 1/2261; F23L 11/005; F16K 27/0218; F16K 1/222; F16K 1/221

(57) ABSTRACT

A flue damper may include a vent pipe with a first side leading to an outlet of the flue damper and a second side leading to an inlet of the flue damper. The flue damper may further include a damper gate with an open state and a closed state, where in the open state, the first side of the vent pipe is in fluid communication with the second side, and where in the closed state, the damper gate interrupts fluid communication between the first side and the second side. A seat flange may be located on an inner wall of the vent pipe, and a seal may be fixed to an outer edge of the damper gate, where a through-portion of the seal extends through a first perforation in the outer edge of the damper gate.

### RELATED APPLICATIONS

This application claims the benefit of U.S. Provisional Application No. 62/633,867, filed Feb. 22, 2018, which is hereby incorporated by reference in its entirety.

### BACKGROUND

Today's high efficiency heating equipment typically operates under a positive vent pressure during operation (i.e., a pressure above atmospheric pressure). The high pressure generally comes from the use of high pressure fans used to push the combustion flue products through the equipment's heat exchanger.

There is generally a need to seal the vents for this type of equipment when two or more heating units are vented to the outside of a building through a common duct. For example, if a first unit is operating, and second and third units are not operating, the flue gases from the first unit could flow into the other two heating units. This potential flow of exhaust gases into the non-operating second and third units can cause equipment failures or leakage of flue gases into the occupied building space. Vent pressurization can occur due to wind loads or other changes to the building's exterior environment.

In prior assemblies, seals have been mounted onto the gate of a flue damper that is closable within a vent pipe to prevent reverse flow of exhaust gasses due to vent pressurization. While these attempts have been met with some success, the mounting process has been difficult, and seals often become dislodged from the gate. This can result in leakage and reduce the efficiency of the flue damper, unsafe situations, and/or downtime due to maintenance. The inadequacy of the connection between seals and gates also hinders the lifespan of those components.

### BRIEF SUMMARY

In one aspect, the present embodiments relate to a flue damper. The flue damper may include a vent pipe with a first side leading to an outlet of the flue damper and a second side leading to an inlet of the flue damper. The flue damper may further include a damper gate with an open state and a closed state, where in the open state, the first side of the vent pipe is in fluid communication with the second side, and where in the closed state, the damper gate interrupts fluid communication between the first side and the second side. A seat flange may be located on an inner wall of the vent pipe, and a seal may be fixed to an outer edge of the damper gate, where a through-portion of the seal extends through a first perforation in the outer edge of the damper gate.

In another aspect, the present embodiments relate to a flue damper with a vent pipe having a first side leading to an outlet of the flue damper and a second side leading to an inlet of the flue damper. A damper gate may be included, and the damper gate may be rotatable between an open state and a closed state, where in the open state, the first side of the vent pipe is in fluid communication with the second side, and where in the closed state, the damper gate interrupts fluid communication between the first side and the second side. A seal flange may be located on an inner wall of the vent pipe, and a seal may be fixed to the seal flange, where a through-portion of the seal extends through a first perforation in the seal flange.

In another aspect, the present embodiments relate to a method. The method may include injection molding a seal through a first perforation, where the first perforation is located in an edge of at least one of (1) a damper gate, and (2) a flange of a flue damper.

In another aspect, the present embodiments relate to a controller for controlling operation of a flue damper. The controller may include a circuit board coupled to a first switch and a second switch, a shaft that rotates as a gate of the flue damper rotates, and a cam that is fixed to the shaft such that when the shaft rotates, the cam also rotates. The cam may include a first arm extending radially outward from the shaft and positioned between the first switch and the second switch.

### BRIEF DESCRIPTION OF THE DRAWINGS

The present embodiments can be better understood with reference to the following drawings and description. The components in the figures are not necessarily to scale, emphasis instead being placed upon illustrating the principles of the invention. Moreover, in the figures, like referenced numerals designated corresponding parts throughout the different views.

FIG. 1 is an illustration showing an arrangement of heating equipment that operates under a positive vent pressure (i.e., above atmospheric pressure) during operation in accordance with certain aspects of the present disclosure.

FIG. 2 is an illustration showing a top perspective view of a flue damper assembly in accordance with certain aspects of the present disclosure.

FIG. 3 is an illustration showing an embodiment of a controller for controlling a gate of a flue damper in accordance with certain aspects of the present disclosure.

FIGS. 4-6 are illustrations showing embodiments damper gates with different types of perforations in accordance with certain aspects of the present disclosure.

FIG. 7 is an illustration showing a perspective view of a damper gate attached to a seal in accordance with certain aspects of the present disclosure.

FIG. 8 is an illustration showing a top view of the damper gate and the seal of FIG. 7.

FIG. 9 is an illustration showing a side sectional view of the damper gate and the seal about line A-A of FIG. 8.

FIG. 10 is an illustration showing an enlarged portion of FIG. 9 about circle B of FIG. 9, and therefore depicts a side sectional view of a portion of the damper gate and the seal of FIGS. 7-9.

FIG. 11 is an illustration showing a ring with a seat flange for communication with a seal in accordance with certain aspects of the present disclosure.

FIG. 12 is an illustration showing a side view of a flue damper in a closed state in accordance with certain aspects of the present disclosure.

FIG. 13 is an illustration showing a ring with a perforated seal flange in accordance with certain aspects of the present disclosure.

FIG. 14 is an illustration showing a ring with a seal flange coupled to a seal in accordance with certain aspects of the present disclosure.

FIG. 15 is an illustration showing a gate with a seat surface for communication with a seal in accordance with certain aspects of the present disclosure.

### DETAILED DESCRIPTION

The present embodiments are described with reference to the drawings in which like elements are referred to by like numerals. The relationship and functioning of the various elements of this invention are better understood from the following detailed description. However, the embodiments of the invention are not limited to the embodiments illustrated in the drawings. It should be understood that in certain instances, details have been omitted which are not necessary for an understanding of the present invention, such as conventional fabrication and assembly.

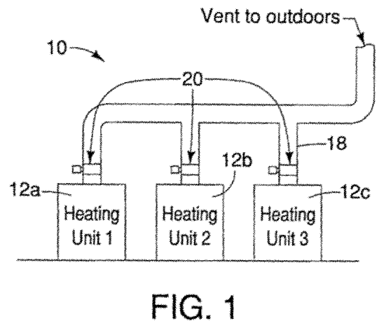

FIG. 1 is an illustration showing an arrangement of heating equipment 10 that operates under a positive (above atmospheric pressure) vent pressure during operation. The high pressure comes from the use of high pressure fans used to push the combustion flue products through the equipment's heat exchanger. Sealing the vents for this type of equipment is generally needed when two or more heating units are vented to the outside of the building through a common vent/duct, as depicted in FIG. 1. For example, if a first unit 12a is operating, and second and third units 12b and 12c are not operating, the flue gases from the first unit 12a could flow through the common exhaust network 18 and into the other two heating units 12b and 12c. This potential flow of exhaust gases into the non-operating second and third units 12b and 12c can cause equipment failures or leakage of flue gases into the occupied building space. Thus, the flue dampers 20 are provided and are designed to close when their respective heating units are not operating.

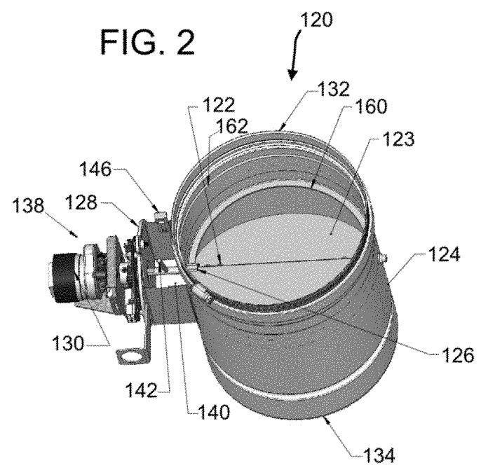

FIG. 2 is an illustration showing a top perspective view of a flue damper 120 in accordance with certain aspects of the present disclosure, which may be used in conjunction with the arrangement of FIG. 1 or any other suitable system. The flue damper 120 may include a gate 122 located within a pipe 124. The pipe 124 may be round, square, triangular, or any other suitable shape. From the perspective of FIG. 2, a first side 132 of the pipe 124 may be closer to an outlet and/or a vent system, and a second side 134 of the pipe 124 may be closer to an inlet and/or heating unit or other appliance. In the remainder of this description, the direction from the first side 132 to the second side 134 will be described as, and referred to, as “vertical,” and the perpendicular direction will be referred to as “horizontal.” These directions are consistent with an exemplary embodiment of the flue damper 120, but it is contemplated that the “vertical” direction could be angled with respect to true vertical.

The gate 122 may be fixed to a shaft 126, and the gate 122 may be movable between an open state (where gasses may flow through) and a closed sealing state by way of rotation of the shaft 126. When in the closed position, the sealing area 123 of the gate 122, along with the below-described seal, may substantially interrupt fluid communication between the first side 132 and the second side 134 of the pipe 124. A flange 160 may be included on an inner wall 162 of the pipe 124 to communicate with a seal (discussed below).

The rotation of the shaft 126 may be controlled by a control assembly 128. The control assembly 128 may include an actuator, such as a motor 130, that causes movement of the shaft 126 (and therefore also the gate 122). A controller 138 may be included for operating the motor 130. The controller 138 may additionally be in communication with the respective heating unit such that it causes the gate 122 to open when the heating unit is turned on and to close when it is turned off. It is also contemplated that the controller 138 may have the capability of stopping the heating unit as a safety measure when the gate 122 is inadvertently close (e.g., through a malfunction or maintenance) and/or when the pipe 124 is otherwise blocked.

An indicator 140 may be coupled to a shaft 126, as shown. The indicator 140 may include an indicator pin 142 that moves when the shaft 126 rotates. Thus, when the shaft 126 is oriented such that the gate 122 is in an open state, the indicator pin 142 may be in one position (or orientation), and when the shaft 126 is rotated such that the gate 122 closes, the indicator pin 142 may move to a second position (or orientation). Since the gate 122 is typically not readily visible within the pipe, the position of the indicator pin 142 may be advantageously visible to a user such that the user can determine if the gate 122 is opened or closed (or somewhere in-between).

In some embodiments, the indicator pin 142 may be attached to at least one sensor (not shown), and the sensor may provide information regarding the position of the gate 122 to another device (e.g., a graphic interface) for displaying the gate position to a user. The sensor information may additionally or alternatively be used for purposes of feedback control of the flue damper 120, its corresponding heating unit, or other equipment as an extra safety measure. Optionally, a hold clamp 146 or other device may be provided to engage the indicator pin 142 to hold/fix it in a certain position when activated (e.g., during maintenance or testing), therefore also holding/fixing the gate 122 in a certain position. The hold clamp 146 may be actuatable manually or automatically.

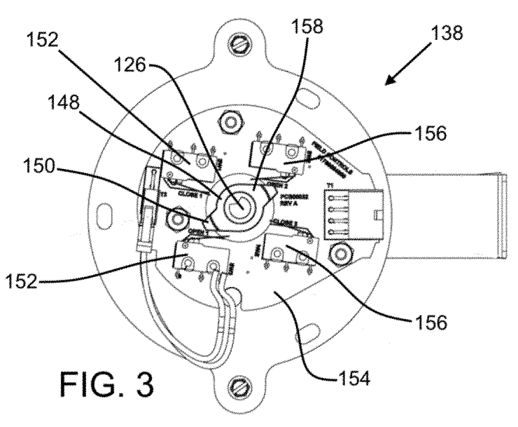

FIG. 3 is an illustration showing an embodiment of the controller 138 for controlling the gate 122 of FIG. 2 (e.g., through operation of the motor 130 of FIG. 2). As shown, the controller 138 may include a cam 148 that is fixed to the shaft 126 such that when the shaft 126 rotates, the cam 148 also rotates. The cam 148 may include at least one arm 150 that extends radially outward and is configured (e.g., sized and shaped) to contact a switch 152a and/or a switch 152b when the cam 148 rotates. The switch 152 may then provide a signal to a circuit board 154 of the controller 138 that indicates the position of the cam 148 (and therefore also the shaft 126 and the gate 122). For example, when the gate 122 (FIG. 2) is fully opened, the cam 148 may be positioned such that the arm 150 contacts the switch 152a. Then, when it rotates to a closed position, the arm 150 may rotate into contact with the switch 152b. Advantageously, the feedback provided by the switches 152a and 152b may be used to confirm the position of the gate 122 (e.g., though generation of an open or closed signal) and thus enhance the safety of the system (e.g., by sending a STOP signal to a heating system when the gate 122 is closed to turn off the gas fired appliance and prevent flue gasses from becoming trapped downstream of the gate 122 and leaking into occupied areas of the building).

To further enhance this safety aspect of the controller 138, a second arm 158 may be included, along with corresponding switches 156a and 156b. The switches 156a and 156b may provide a redundant signal such that safety is not compromised if one or more of the switches 152a and 152b fails. In some embodiments, the controller 138 may be programmed to recognize an inconsistency between the signals received from the switches 152a and 152b and the switches 156a and 156b. An inconsistency may trigger a shutdown of the system and an indication that maintenance is needed (e.g., through sending a maintenance signal that causes lighting an indicator light, an indication on a display/interface, etc.).

In some embodiments, the arms 150 and 158 may be positioned on the cam 148 such that they contact their respective switches in a desired sequence. For example, when the gate closes, the controller 138 may be designed such that the switch 152b is actuated before the second arm 158 contacts the switch 156b. Thus, a shutdown of the system may occur prior to the second arm 158 making contact with the switch 156b (based on the signal from the switch 152b). However, if the switch 152b fails, the second arm 158 will contact the switch 156b, safely triggering the shutdown. Also, the controller 138 may immediately recognize that the sensor 152b has malfunctioned since the signal came from the switch 156b rather than the switch 152b. As described above, the controller 138 may then provide an indication of the need for maintenance such that the sensor 152b can be fixed or replaced.

As shown in FIG. 3 (and also in FIG. 2), a wire protector 230 may be included adjacent to the circuit board 154 of the controller 138, and the wire protector 230 may extend from the indicator 140 (see FIG. 2) or from another suitable location. The wire protector 230 may include an arm 232 that leads to a panel 234 with an opening 236. During operation, a wire 238 (or multiple wires) may extend through the opening 236 when its end is plugged into a socket 240. The wire 238 may lead to other components of the system (e.g., to an interface and/or to the gas fired appliance). The panel 236 may ensure the wire 238 retains a suitable position with respect to the socket 240 such that it does not become dislodged, kinked, etc.

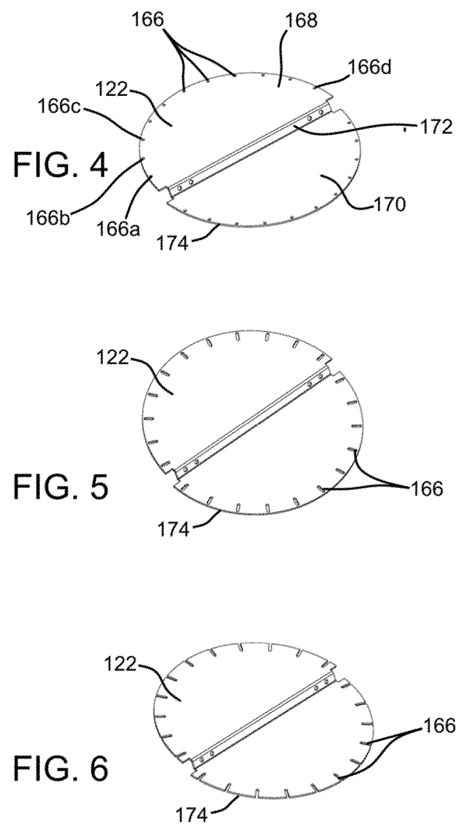

FIGS. 4-6 are illustrations showing the damper gate 122 with different embodiments of perforations 166. Referring to FIG. 4, the gate 122 may include a first gate portion 168 and a second gate portion 170 connected via a central portion 172. The central portion 172, which may directly contact and secure to the above-described shaft, may be slanted with respect to the first gate portion 168 and/or the second gate portion 170, and in some embodiments may be substantially perpendicular with respect to the first gate portion 168 and the second gate portion 170. This structure of the gate 122 may be formed by pressing a single piece of sheet metal with a manufacturing press, but other methods of manufacturing are also contemplated.

As a result this gate structure, the first gate portion 168 and the second gate portion 170 may be offset with respect to one another, such that an “upper” portion (e.g., the first gate portion 168) is disposed vertically above, or is otherwise offset with respect to, a “lower” portion (e.g., the second gate portion 170) when the gate 122 is horizontal. As described in more detail below, this embodiment is advantageous for providing enhanced communication (e.g., contact) between a seat surface and a seal located on an outer edge 174 of the gate 122. An offset structure and some of the associated advantages are described in U.S. patent application Ser. No. 13/947,773 to Guzorek, published as U.S. 2014/0027660A1, which is herein incorporated by reference in its entirety.

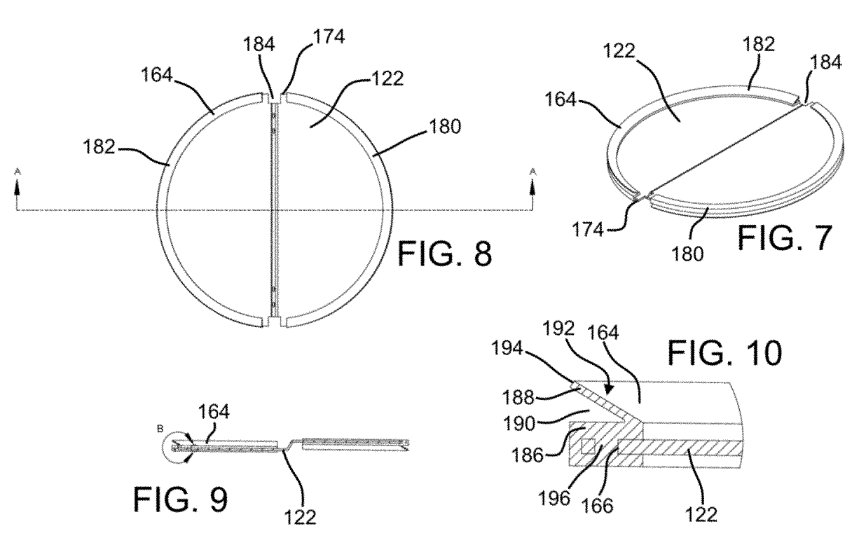

The perforations 166 may be included adjacent to the edge 174 of the gate 122 for receiving material of a seal (e.g., the seal 164 of FIG. 7). The perforations 166 may be about ½″ or less (e.g., about ⅛″ or less) from the edge 174. The perforations 166 may be configured (e.g., sized and shaped) or otherwise adapted for providing a suitable engagement with a seal, for example when the seal is engaged through injection molding as described in more detail below. As shown in FIG. 4, the perforations 166 may be circular in shape (e.g., with a diameter of about ⅛″ in some embodiments), which may be advantageous due to their simplicity of manufacturing (e.g., by using a drill press, a laser cutter, a stamping or punching device, and/or another suitable device). The perforations 166 may extend completely through the damper gate 122 as shown, or only partially through the damper gate 122 in other embodiments.

In some embodiments, the perforations 166 may vary in size. For example, the perforation 166a depicted in FIG. 4 may larger than the perforation 166b, and the perforation 166b may be larger than the perforation 166c. The size of the perforations 166 may continue to decrease around the edge of the gate 122 towards the perforation 166d. This embodiment may be advantageous where an injection-molding process is used to form a seal (i.e., a seal 164 as shown in FIG. 7). For example, the larger perforations (e.g., the perforation 166a and those adjacent to it) may be located the farthest from the entry point of material being injected into a mold, and the smaller perforations 166 (e.g., the perforation 166d and those adjacent to it) may be located near the entry point of material being injected into the mold. As a result, material that has flowed father through the mold (which may have cooled such that it is more viscous) will have a less-restrictive larger opening to extend through, enhancing the quality of the final seal. The size of the perforations 166 may be optimized to account for distance from an entry point during injection molding. While any ratio is calculated, in some embodiments, at least one perforation 166 (i.e., the perforation 166a) may be at least 10% smaller in diameter, than another perforation 166 located about the same distance from the edge of the gate (e.g., the perforation 166d). For example, the perforation 166a may have a diameter that is about 20% smaller, about 30% smaller, about 50% smaller, or even less.

Other perforation shapes are also contemplated. For example, as shown in FIG. 5, the perforations 166 may be elongated such that they are discorectangle/obround in shape, which may be readily formed by a drill press (e.g., by moving the drill bit with respect laterally and vertically when forming the perforations 166), a laser cutter, a stamping or punching device, etc. In another embodiment, shown in FIG. 6, the damper gate 122 may include perforations 166 that are shaped as slots that extend to the edge 174, which may be advantageous where a seal is formed separately and then later coupled to the damper gate 122 (e.g., when extensions of a seal slidingly engage the perforations 166, for example). Any other suitable shape for perforations of the damper gate 122 can be used, and in some embodiments, a damper gate 122 may have certain perforations that differ from others in size and/or shape.

FIG. 7 is an illustration showing a perspective view of the damper gate 122 attached to a seal 164. FIG. 8 is an illustration showing a top view of the damper gate 122 and the seal 164 of FIG. 7. Referring to FIGS. 7-8, the seal 164 may be secured to the edge 174 of the damper gate 122 such that it extends around a majority, or the entirety, of the perimeter of the damper gate 122. In some embodiments, the seal 164 may be formed primarily, and/or entirely, of a synthetic rubber, such as ethylene propylene diene monomer, one or more fluorinated elastomers, and/or another suitable material. As shown, the seal 164 may include a first seal portion 180 and a second seal portion 182. In the depicted embodiment, the first seal portion 180 and the second seal portion 182 are separated by cutouts 184. Thus, the first seal portion 180 and the second seal portion 182 may be formed separately, or formed together and then separated (e.g., cut). In other embodiments, the first seal portion 180 and the second seal portion 182 may be continuous, and it is contemplated that more than two distinct seal portions may be included.

FIG. 9 is an illustration showing a side sectional view of the damper gate 122 and the seal 164 about line A-A of FIG. 8. FIG. 10 is an illustration showing an enlarged portion of FIG. 9 about circle B of FIG. 9. Referring to FIGS. 9-10, the seal 164 may generally include a base portion 186 and an extension 188, where an interior space 190 is disposed between the base portion 186 and the extension 188 (at least in an open/default state). A free end 194 of the extension 188 may point in a radially-outward direction (e.g., such that it faces towards inner walls of an associated pipe). In other embodiments, the seal 164 may have at least one portion with an extension pointing radially-inward. The extension 188 may be deformable/compliable such that, when a seal surface 192 of the extension 188 contacts and is pressed against a seat surface (described in more detail below), the extension 188 deforms into the interior space 190 and towards the base portion 186 of the seal 164. Advantageously, as the gate 122 is moved into a closed state (thus pressing the extension 188 against a seat surface), the extension 188 will deflect in an at least partially vertical manner which may, in effect, cause the extension 188 to form and maintain a sufficient sealing contact with the seat surface. A similar feature is described in U.S. patent application Ser. No. 13/947,773, which is incorporated by reference above.

As shown by FIG. 10, the seal 164 may include a through-portion 196 that extends through the perforation 166 of the gate 122. The through-portion 196 may act to enhance the connection between the seal 164 and the gate 122, thereby reducing the chance of the seal 164 falling off or otherwise disengaging with the gate 122. Further, the connection formed by the through-portion 196 of the seal 164 and the perforation 166 may enhance the structural integrity, and thus performance, of the seal 164 (e.g., since it is secured well along the entire perimeter of the gate). In sum, the enhanced connection between the seal 164 and the gate 122 may be advantageous due to an increase in the efficiency and safety of the entire flue damper due to increased performance and lifespan of the seal 164.

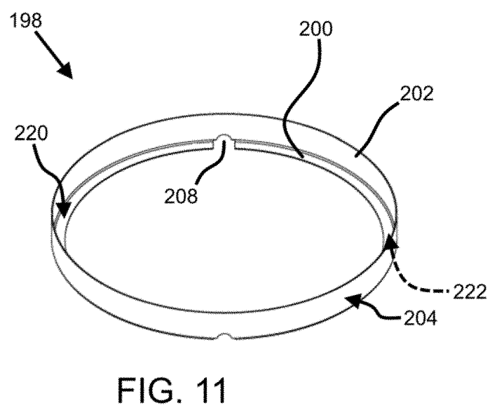

FIG. 11 is an illustration showing a ring 198 with the seat flange 200. The ring 198 may be formed of any suitable material, such as a metal (e.g., stainless steel) in exemplary embodiments. A vertical portion 202 of the ring 198 may have an outer surface 204 that is configured (e.g., sized and shaped) to secure to an inner wall of the pipe (such as pipe 124 of FIG. 2). For example, the outer surface 204 may be welded, screwed, glued, clamped (e.g., with a worm clamp), or otherwise secured to the pipe. The seat flange 200 may extend from the vertical portion 202. A pair of cutouts 208 may be included in the seat flange 200, which may be positioned for receipt of the shaft 126 that moves the gate 122 (as shown in FIG. 2).

The seat flange 200 may have at least one seat surface for contacting the seal 164 (of FIGS. 8-10). As described below, a first seat surface 220 may be on a top side of the seat flange 200 and a second seat surface 222 may be on a bottom side of the seat flange 200. The seat surfaces 220 and 222 may be substantially planar in shape to provide adequate contact with a seal, and they may be solid (e.g., without perforations) to suitably block fluid communication from one side of the seat flange 200 to the other when the flue damper is in a close.

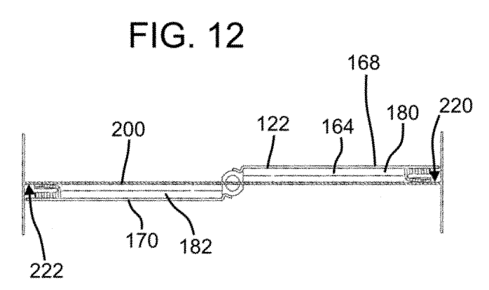

FIG. 12 is an illustration showing a side view of the damper gate 122 in a closed state such that the seal 164 is pressed against the seat surfaces 220 and 222 of the seat flange 200. As shown, the first seat surface 220 of the seat flange 200 may be on a top side of the seat flange 200, and the second seat surface 222 of the seat flange 200 may be on a bottom side of the seat flange 200. As explained above, the offset between the first gate portion 168 and the second gate portion 170 may position the first seal portion 180 for contact with the first seat surface 220 and the second seal portion 182 for contact with the second seat surface 222. Advantageously, contact between the seal 164 and the seat flange 200 may occur around the perimeter of the gate 122 without blocking the gate 122 from rotating back to its open state (e.g., through a clockwise rotation from the perspective of FIG. 12).

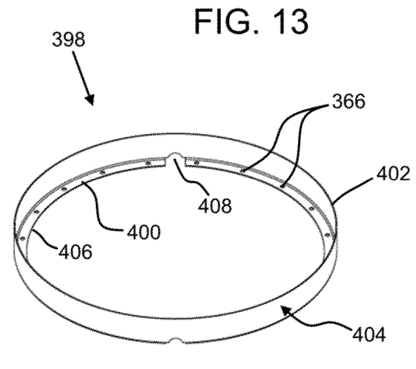

In some embodiments, instead of (or in addition to) including a seal on a damper gate and a seat surface on a seat flange, a seal may be included on a flange fixed to the pipe and the respective seat may be included with a damper gate. FIGS. 13-16 describe such an embodiment.

FIG. 13 is an illustration showing a ring 398 with the seal flange 400. The ring 398 may be formed of any suitable material, such as metal (e.g., stainless steel in certain exemplary embodiments). A vertical portion 402 of the ring 398 may have an outer surface 404 that is configured (e.g., sized and shaped) to secure to an inner wall of the pipe. For example, the outer surface 404 may be welded, screwed, glued, clamped (e.g., with a worm clamp), or otherwise secured to the pipe.

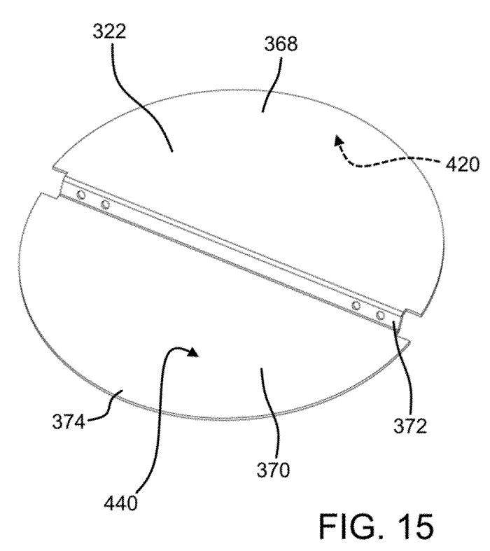

The seal flange 400 may extend from the vertical portion 402 towards the center of the respective pipe. A pair of cutouts 408 may be included in the seal flange 400, which may be positioned for receipt of a shaft that moves the gate 322 (shown in FIG. 15). Further, one or more perforations 366 may be included in the seal flange 400. As described above with respect to the perforations 166 of the gate 122 (of FIGS. 4-6), the perforations 366 may have any suitable size and shape. For example, the perforations 366 may be substantially circular, discorectangle/obround, slotted, or the like. Preferably (but without limitation), the perforations 366 extend completely through the seal flange 400. Like the embodiments described above (e.g., with reference to the gate 122 of FIG. 4), the perforations 366 may vary in size to increase the efficiency and/or otherwise enhance an injection-molding process and the final characteristics of an injection-molded seal.

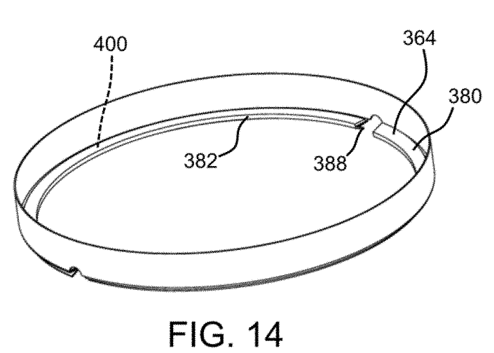

FIG. 14 is an illustration showing the seal flange 400 being fixed or otherwise secured to the seal 364. The seal 364 may be similar to the seal 164 described above with reference to FIG. 10, but instead of being located on a damper gate and using a fixed flange as a seat surface, it is located on the seal flange 400 and uses the gate 322 (FIG. 15) as a seat surface. The seal 364 may be fixed or otherwise coupled to the seal flange 400 in any suitable manner. For example, the seal 364 may be injection molded around an edge 406 of the seal flange 400 (and the edge 406 is shown in FIG. 13). In non-limiting exemplary embodiments, the seal 364 may have a through-portion (not shown in FIG. 14) that extends through the entirety of the seal flange 400 (e.g., through the perforations 366 of FIG. 13). Advantageously, the above-described perforations 366 of the seal flange 400 may enhance the connection between the seal flange 400 and the seal 364 for at least the same reasons as those described above with respect to through-portions 196 of FIG. 10.

As shown in FIG. 14, the seal 364 may have a first seal portion 380 and a second seal portion 382. The first seal portion 380 may have an extension 388 (e.g., extending from a base portion of the seal as described above) that extends in at least partially in an upward-vertical direction on the first seal portion 380, and the extension 388 may extend in at least partially in a downward-vertical direction on the second seal portion 382. Advantageously, when the gate 322 (FIG. 15) rotates to close, one side of the gate 322 will converge on the extension 388 on the first seal portion 380, and the other opposite side of the gate 322 will converge on the extension 388 of the second seal portion 382.

FIG. 15 shows the gate 322 for use with the seal flange 400 of FIG. 14. Like the gate 122 described above with reference to FIGS. 4-6, the gate 322 may have a central portion 372 (e.g., that may couple to a rotatable shaft). The central portion 372 may be slanted with respect to the first gate portion 368 and the second gate portion 370, and in some embodiments may be substantially perpendicular with respect to the first gate portion 368 and the second gate portion 370. The first gate portion 368 and the second gate portion 370 may be offset with respect to one another, such that an “upper” portion (e.g., the first gate portion 368) is disposed vertically above, or is otherwise offset with respect to, a “lower” portion (e.g., the second gate portion 370) when horizontal. Advantageously, this offset construction may provide suitable contact of a first seat surface 420 of the first gate portion 368 with a first seal portion 380 of the seal 364 (shown in FIG. 14) and a second seat surface 422 with a second seal portion 382 of the seal 364 (FIG. 14).

An edge 374 of the gate 322 may be substantially flat and may lack perforations or other substantial deviations from its solid and planar structure. The solid structure (e.g., lack of perforations) may be advantageous for providing the gate 322 with suitable seat surfaces 420 and 422 for communication with the seal flange 400 and seal 364 (of FIG. 14), and for preventing fluid flow through the gate 322 when the associated flue damper is closed.

While various embodiments of the invention have been described, the invention is not to be restricted except in light of the attached claims and their equivalents. Moreover, the advantages described herein are not necessarily the only advantages of the invention and it is not necessarily expected that every embodiment of the invention will achieve all of the advantages described.

We claim:

1. A flue damper, comprising:
a vent pipe with a first side leading to an outlet of the flue damper and a second side leading to an inlet of the flue damper;
a damper gate with an open state and a closed state, wherein in the open state, the first side of the vent pipe is in fluid communication with the second side, and wherein in the closed state, the damper gate interrupts fluid communication between the first side and the second side;
a seat flange located on an inner wall of the vent pipe; and
a seal fixed to an outer edge of the damper gate, wherein a through-portion of the seal extends through a first perforation in the outer edge of the damper gate.

2. The flue damper of claim 1, wherein the seal includes a seal surface positioned to abut the seat flange when the damper gate is in the closed state.

3. The flue damper of claim 1, wherein the seal includes a first seal portion and a second seal portion, wherein the first seal portion includes a first extension and wherein the second seal portion includes a second extension, and wherein the first extension abuts a first side of the seat flange and the second extension abuts a second side of the seat flange when the damper gate is in the closed state.

4. The flue damper of claim 1, wherein the damper gate includes a first gate portion, a second gate portion, and a central portion therebetween, and wherein the central portion is angled with respect to at least one of the first gate portion and the second gate portion such that the first gate portion is offset with respect to the second gate portion.

5. The flue damper of claim 1, further comprising a rotatable shaft coupled to the damper gate for moving the damper gate between states, wherein the rotatable shaft is movable by an actuator.

6. The flue damper of claim 5, wherein the actuator is coupled to a control assembly, the control assembly including a cam attached to the rotatable shaft, wherein an arm of the cam contacts a switch of the control assembly when the damper gate is in at least one state.

7. The flue damper of claim 5, wherein an indicator pin is fixed to the rotatable shaft such that the indicator pin is in a first position when the damper gate is in the open state and a second position when the damper gate is in the closed state.

8. The flue damper of claim 7, further comprising a hold clamp for engaging the indicator pin, wherein the indicator pin is fixed with respect to the hold clamp when the hold clamp is engaged.

9. The flue damper of claim 1, wherein the outer edge of the damper gate has a plurality of perforations including the first perforation, and wherein the plurality of perforations decrease in size along the outer edge of the damper gate such that the first perforation has a diameter that is at least 10% larger than a diameter of a second perforation.

10. A flue damper, comprising:
a vent pipe with a first side leading to an outlet of the flue damper and a second side leading to an inlet of the flue damper;
a damper gate with an open state and a closed state, wherein in the open state, the first side of the vent pipe is in fluid communication with the second side, and wherein in the closed state, the damper gate interrupts fluid communication between the first side and the second side;
a seal flange located on an inner wall of the vent pipe; and
a seal fixed to the seal flange, wherein a through-portion of the seal extends through a first perforation in the seal flange.

11. The flue damper of claim 10, wherein the seal includes a seal surface positioned to abut a seat surface of the damper gate when the damper gate is in the closed state.

12. The flue damper of claim 10, wherein the seal includes a first seal portion and a second seal portion, wherein the first seal portion includes a first extension and wherein the second seal portion includes a second extension, and wherein the first extension abuts a first side of the damper gate and the second extension abuts a second side of the damper gate when the damper gate is in the closed state.

13. The flue damper of claim 10, wherein the damper gate includes a first gate portion, a second gate portion, and a central portion therebetween, and wherein the central portion is angled with respect to at least one of the first gate portion and the second gate portion such that the first gate portion is offset with respect to the second gate portion.

14. The flue damper of claim 10, further comprising a rotatable shaft coupled to the damper gate for moving the damper gate between states, wherein the rotatable shaft is movable by an actuator.

15. The flue damper of claim 14, wherein the actuator is coupled to a control assembly, the control assembly including a cam attached to the rotatable shaft, wherein an arm of the cam contacts a switch of the control assembly when the damper gate is in at least one state.

16. The flue damper of claim 14, wherein an indicator pin is fixed to the rotatable shaft such that the indicator pin is in a first position when the damper gate is in the open state and a second position when the damper gate is in the closed state.

17. The flue damper of claim 16, further comprising a hold clamp for engaging the indicator pin, wherein the indicator pin is fixed with respect to the hold clamp when the hold clamp is engaged.

18. The flue damper of claim 10, wherein an outer edge of the damper gate has a plurality of perforations including the first perforation, and wherein the plurality of perforations decrease in size along the outer edge of the damper gate such that the first perforation has a diameter that is at least 10% larger than a diameter of a second perforation.

19. A method, comprising:
injection molding a seal through a first perforation,
wherein the first perforation is located in an edge of at least one of a damper gate and a flange of a flue damper.

20. The method of claim 19, further comprising forming a plurality of perforations in the damper gate of the flue damper, the plurality of perforations including the first perforation, wherein the first perforation has a diameter that is at least 10% larger than a diameter of a second perforation of the plurality of perforations.
